(19) United States
(12) Patent Application Publication
(10) Pub. No.: US 2015/0323900 A1
(43) Pub. Date: Nov. 12, 2015

(54) METHOD AND APPARATUS FOR ENHANCEMENT OF RESOLUTION AND WIDE VIEWING ANGLE DIGITAL HOLOGRAPHIC SYSTEM

(71) Applicant: Electronics and Telecommunications Research Institute, Daejeon (KR)

(72) Inventors: Kwan Jung OH, Daejeon (KR); Jae Han KIM, Gwacheon-si Gyeonggi-do (KR); Jin Woong KIM, Daejeon (KR); Tae One KIM, Daejeon (KR); Kyung Ae MOON, Daejeon (KR); Bong Ho LEE, Daejeon (KR); Hyon Gon CHOO, Daejeon (KR)

(21) Appl. No.: 14/707,347

(22) Filed: May 8, 2015

(30) Foreign Application Priority Data
May 9, 2014 (KR) 10-2014-0055659

(51) Int. Cl. G03H 1/26; G03H 1/04; G03H 1/08

(52) U.S. Cl. CPC G03H 1/265; G03H 1/0891; G03H 1/0402

(57) ABSTRACT

An apparatus and method for enhancing a resolution and a wide viewing angle of a holographic system is provided, the method including determining a multiple N of a target resolution and a wide viewing angle based on a resolution of a spatial light modulator (SLM) and an angle of view of a condensing lens, generating a plurality of hogels from a target image based on the determined multiple N of the target resolution and wide viewing angle, and recording the target image on a recording medium using a condensed beam obtained from a parallel beam that loads the plurality of hogels passing through the condensing lens.

### CROSS-REFERENCE TO RELATED APPLICATION

This application claims the priority benefit of Korean Patent Application No. 10-2014-0055659, filed on May 9, 2014, in the Korean Intellectual Property Office, the disclosure of which is incorporated herein by reference.

### BACKGROUND

1. Field of the Invention

Embodiments of the present invention relate to an apparatus and a method for enhancing a resolution and a wide viewing angle of a holographic system.

2. Description of the Related Art

In general, a method of recording a hologram in a holographic film may be classified into an analog method and a digital method.

The analog method generates a hologram through interference between a light reflected by irradiating a beam onto an object to be recorded using a coherence light source such as laser and a reference beam corresponding to a pure laser beam. The digital method generates an interference pattern for each small unit of a hologram element, for example, a hogel. In the digital method, a hologram is generated through interference with a reference beam by condensing an image generated in advance at each hogel.

Limits of an object size or object acquisition may be less of an issue in the digital method than the analog method. The digital holographic recording method is highly contingent on a performance of a hogel. The hogel, for example, a small single pixel on a recording film, is characterized by reproducing an object beam recorded in a reference beam environment of the same recording conditions.

The performance of the hogel may be measured by a hogel resolution that indicates a number of light bundles to be dispersed from a single hogel, and a size of a wide viewing angle to be covered by a single hogel.

The hogel resolution is identical to a resolution of a spatial light modulator (SLM) to be used during object beam generation. In general, development of a high resolution SLM is difficult and expensive.

As used herein, a viewing angle may refer to a range of an angle in which the aforementioned hogel resolution, for example, a light bundle dispersed from a single hogel, is capable of being dispersed. For example, when a viewing angle of a single hogel is “45” degrees, a light emitted from the hogel may not be visible beyond a range of “45” degrees. In this example, a viewing angle provided in a digital hologram recording medium may be identical to an angle of view of a condensing lens used in recording. However, when a converging lens is used as a condensing lens, the greater an angle of view, the greater a distortion and a cost. Also, a single angle of view may be provided for each lens using the converging lens.

Accordingly, there is a need for a method of enhancing a spatial resolution and a wide viewing angle of a hogel to solve such issues.

### SUMMARY

An aspect/embodiment of the present invention provides an apparatus and a method of enhancing a resolution and a viewing angle of a hogel without changing a spatial light modulator (SLM) and a condensing lens in order to resolve issues posed by high dependency of a resolution and a viewing angle of a hogel on a resolution of the SLM and an angle of view of the condensing lens used in an object beam condenser in digital holographic printing.

According to an aspect of the present invention, there is provided a method of enhancing a resolution and a wide viewing angle of a digital holographic system, the method including determining a multiple N of a target resolution and a wide viewing angle based on a resolution of an SLM and an angle of view of a condensing lens, generating a plurality of hogels from a target image based on the determined multiple N of the target resolution and the wide viewing angle, and recording the target image on a recording medium using a condensed beam obtained from a parallel beam that loads the plurality of hogels passing through the condensing lens.

The target image may include the plurality of hogels.

The determining of the multiple N of the target image and the wide viewing angle based on the resolution of the SLM and the angle of view of the condensing lens may include determining a height of a film transfer stage based on the determined resolution.

The generating of the plurality of hogels from the target image based on the determined multiple N of the target resolution and the wide viewing angle may include generating the plurality of hogels by dividing a hogel generated in advance into sub-regions.

The recording of the target image on the recording medium using the condensed beam obtained from the parallel beam that loads the plurality of hogels passing through the condensing lens may include recording the condensed beam by diagonally condensing at a film transfer stage that transfers the recording medium.

The recording of the condensed beam by diagonally condensing at the film transfer stage that transfers the recording medium may include recording the target image by diagonally tilting the film transfer stage.

The recording of the target image by diagonally tilting the film transfer stage may include adjusting a tilt angle of the film transfer stage to perpendicularly intersect one line of the condensed beam.

The recording of the target image by diagonally tilting the film transfer stage may include transferring the film transfer stage in a unit of the plurality of hogels by adjusting the condensed beam to the unit of the plurality of hogels in an absence of a tilt of the film transfer stage.

The recording of the target image by diagonally tilting the film transfer stage may include transferring the film transfer stage in a unit of a value obtained by multiplying a size of the plurality of hogels and a cosine value of the tilt angle of the film transfer stage in a presence of a tilt of the film transfer stage.

The recording of the target image by diagonally tilting the film transfer stage may include adjusting a tilt of a condenser that transfers the condensed beam to diagonally condense the condensed beam at the film transfer stage.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a digital holographic system according to related art;

FIG. 2 is a diagram illustrating a comparison conducted on methods of generating a hogel resolution of 2000 pixels (2K)×2K according to an embodiment of the present invention;

FIG. 3 is a flowchart illustrating a method of enhancing a resolution and a wide viewing angle of a digital holographic system according to an embodiment of the present invention;

FIG. 4 is a diagram illustrating an example of an existing normalized hogel image according to related art;

FIG. 5 is a diagram illustrating an example of a method of enhancing a resolution and a wide viewing angle of a digital holographic system according to an embodiment of the present invention;

FIG. 6 is a diagram illustrating a beam and a hogel viewed from a bottom of a recording medium, for example, a film, according to an embodiment of the present invention; and

FIG. 7 is a diagram illustrating a method of calculating a tilt angle of a film transfer stage according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a method of enhancing a resolution of a wide viewing angle of a digital holographic system and the digital holographic system that performs the method will be described with reference to accompanying drawings.

According to an aspect of the present invention, as previously described, a partial recording method is applied to enhance the hogel resolution and the wide viewing angle when recording a hologram.

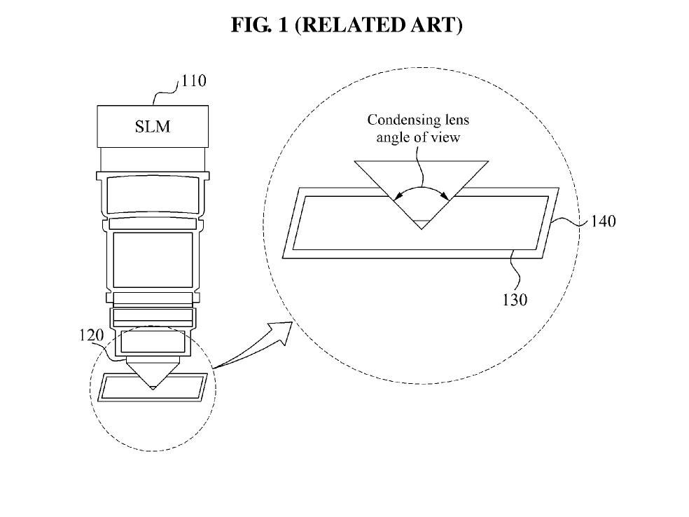

FIG. 1 is a diagram illustrating a configuration of a digital holographic system according to related art. For example, a configuration of a condenser of the digital holographic system is illustrated.

Referring to FIG. 1, a spatial light modulator (SLM) 110 may load a single target image to be recorded, and insert the target image into a condensing lens 120 below in a form of a parallel beam.

In this example, a number of light bundles represented in the condensing lens 120 may be determined based on a resolution determined in the SLM 110. When a beam condensed in the condensing lens 120 is viewed, an angle of view of the condensing lens 120 may be observed. The angle of view of the condensing lens 120 may be identical to a wide viewing angle provided by a single hogel, subsequent to being recorded at an angle of incidence of the condensed beam on a surface of a recording medium 130, for example, a recording film.

However, a condensing lens that provides a wide angle of view as shown in FIG. 1 has a lens distortion in a pin-cushion type and costs a great deal. Accordingly, an aspect of the present invention may provide required refinement of the SLM 110 to generate a hogel image, and an apparatus for controlling the condensing lens 120 and a film transfer stage 140 to transfer the recording medium 130.

According to an aspect of the present exemplary embodiment, effects of holographic recording achieved by a high resolution SLM and a condensing lens having a wide angle of view are to be represented through use of the SLM 110 having a relatively small resolution and the condensing lens 120 having a relatively small angle of view.

To this end, a partial recording on the recording medium 130 may be necessary. For example, a currently set region of a hogel may be divided into four sub-hogels to be recorded respectively to increase a resolution of the SLM 110 and an angle of view of the condensing lens 120 by a factor of two.

Also, an apparatus for adjusting a tilt may be provided on the film transfer stage 140 that transfers the recording medium 130 to diagonally record so as to allow a bundle of lights dispersed from the condensing lens 120 not to overlap one another. According to the present exemplary embodiment, an apparatus for generating a hogel image, a film transfer stage, and an apparatus for controlling the film transfer stage may need to be refined.

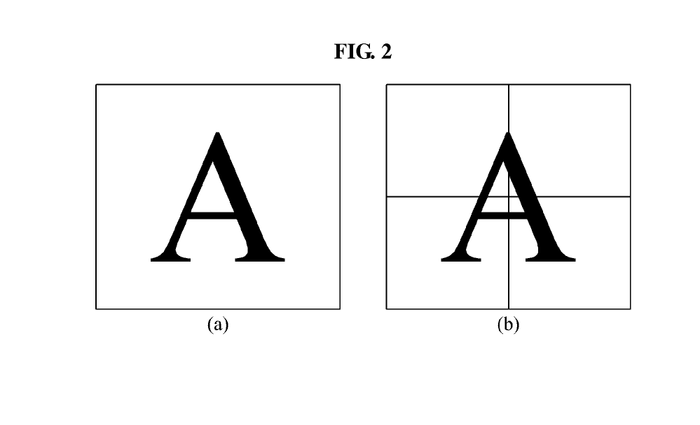

FIG. 2 is a diagram illustrating a comparison conducted on methods of generating a hogel resolution of 2000 pixels (2K)×2K according to an embodiment of the present invention.

A box (a) of FIG. 2 illustrates an input hogel resolution of 2K×2K, and a box (b) of FIG. 2 illustrates a sub-hogel having a hogel resolution of 2K×2K obtained by inputting a hogel of 1K×1K four times.

According to an embodiment, to provide a hogel resolution of 2K×2K, a method of recording using a single SLM having a resolution of 2K×2K is illustrated with reference to the box (a) of FIG. 2, and a method of recording by an SLM having a hogel resolution of 1K×1K four times is illustrated with reference to the box (b) of FIG. 2.

When an SLM used herein has a hogel resolution of 1K×1K, a single hogel having a resolution of 2K×2K may need to be divided into four sub-hogels to be recorded respectively as shown in the box (b) of FIG. 2 to obtain a holographic image having a resolution of 2K×2K.

When generating a hogel image, the SLM may generate a single hogel in a resolution of 2K×2K, and divide the single hogel into four.

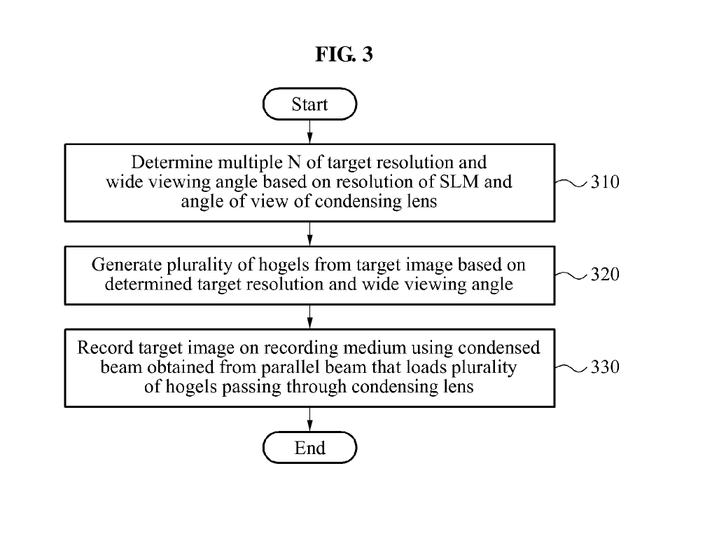

FIG. 3 is a flowchart illustrating a method of enhancing a resolution and a wide viewing angle of a digital holographic system according to an embodiment of the present invention. The digital holographic system according to an embodiment of the present invention may include an SLM, a condensing lens, and a film transfer stage to transfer a recording medium.

In operation 310, a multiple N of a target resolution and a wide viewing angle may be determined based on a resolution of the SLM and an angle of view of the condensing lens. For example, as previously described above, the resolution and the wide viewing angle may be determined to be generated through being increased by a factor of two. The multiple N may be determined by a user. In this example, the determined wide viewing angle may be set not to exceed 180 degrees.

In holographic recording, a resolution of a result of the recording may be based on a degree of condensation of a beam to be condensed at a condensing lens. According to an embodiment, a height of a film transfer stage including a recording medium may be determined to determine the degree of condensation of the condensed beam. For example, when the height of the film transfer stage is lowered to adjust a smaller form of a beam to be condensed, a relatively high resolution hogel may be recorded on an identical size of the recording medium.

In operation 320, a plurality of hogels may be generated from a target image based on the determined multiple N of the target resolution and wide viewing angle. In this example, the target image may include the plurality of hogels. The SLM may load the target image to be recorded to generate the plurality of hogels. As shown in the box (b) of FIG. 2, a hogel of an existing resolution is divided to be generated into sub-hogels.

In operation 330, the target image may be recorded on the recording medium using a condensed beam obtained from a parallel beam that loads the plurality of hogels passing through the condensing lens.

According to an embodiment, the condensed beam that passes through the condensing lens may be recorded through being diagonally condensed at the film transfer stage that transfers the recording medium.

For one example, the film transfer stage may be diagonally tilted by diagonally condensing the condensed beam at the film transfer stage. For another example, a tilt of a condenser to transfer the condensed beam may be adjusted to diagonally condense the condensed beam at the film transfer stage.

The film transfer stage may transfer the recording medium by a size of a hogel in a manner of scanning to allow each hogel to be recorded in order to record a whole of the target image on the recording medium.

According to an embodiment, when the target image is recorded in an absence of a tilt of the film transfer stage, the target image may be recorded by adjusting the condensed beam to a size of a sub-hogel, and transferring the film transfer stage in a unit of the size of the sub-hogel. According to another embodiment, when the target image is recorded in an presence of a tilt of the film transfer stage, the target image may be recorded by transferring the film transfer stage in a unit of a value obtained by multiplying a size of the a hogel and a cosine value of an angle of the tilt of the film transfer stage.

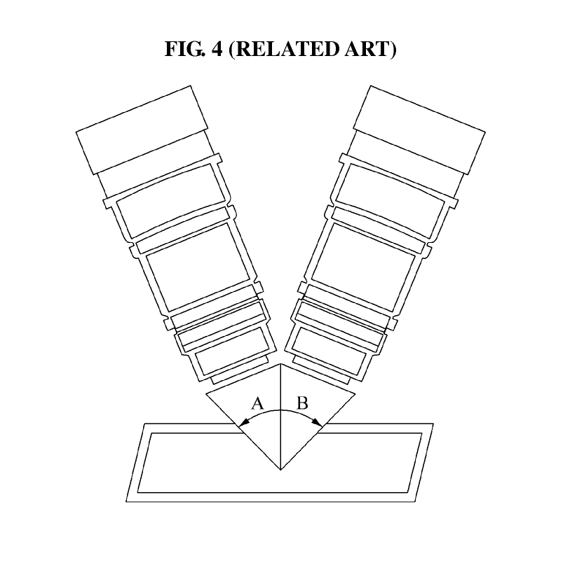

FIG. 4 is a diagram illustrating an example of an existing normalized hogel image according to related art. A method of enhancing a wide viewing angle may be performed as embodiment illustrated in FIG. 4.

A user may determine a desired multiple of a resolution and a wide viewing angle based on a resolution of a real-time SLM and an angle of view of a condensing lens. As previously described above, the determined wide viewing angle may be set not to exceed 180 degrees. For example, when an SLM having a 1K×1K resolution and a condensing lens having an 60 degrees of an angle of view are provided, and the wide viewing angle and the resolution are determined to be two times greater, a hogel resolution of 2K×2K and a wide viewing angle of 120 degrees may be discussed according to an embodiment.

Hereinafter, descriptions pertaining to a method of recording a hogel in a size of 2 millimeters (mm)×2 mm that provides a hogel resolution of 2K×2K and a wide viewing angle of 120 degrees will be provided.

As previously described above, a hierarchical recording method may be adopted to increase efficiency in hologram recording. In the hologram recording, a degree of condensation may determine a resolution of a result of the recording. For example, a hogel image loaded in an SLM may pass through a condensing lens to be output in a form of a condensed beam and recorded on a recording medium. In this example, a relatively high resolution image may be recorded by a relatively small form of a beam.

In this example, a single hogel image may be loaded in the SLM and a height of a film transfer stage may be adjusted to perform the recording in a unit of a single pixel. When a size of the hogel to be recorded is determined, the SLM may load the hogel generated in a corresponding size one piece each, and perform the recording by transferring the recording medium in a zigzag manner in horizontal and vertical directions by a number of hogels.

In an existing system, a size of a hogel to generate a single record may be fixed and may not change until the recording is complete. However, due to the fixed size of the hogel, recording complexity may remain the same at all times irrespective of information of an image to be recorded, resulting in complexity of hogel image generation being identically maintained at all times irrespective of content of the target image.

Referring to FIG. 4, a method in which an angle of view is implemented through being doubled by use of two condensing lenses having an identical wide viewing angle is illustrated. However, such implementation of FIG. 4 may require two SLMs in addition to the condensing lenses, and when extended to a two-dimensional (2D) space, four condensing lenses and four SLMs may be needed.

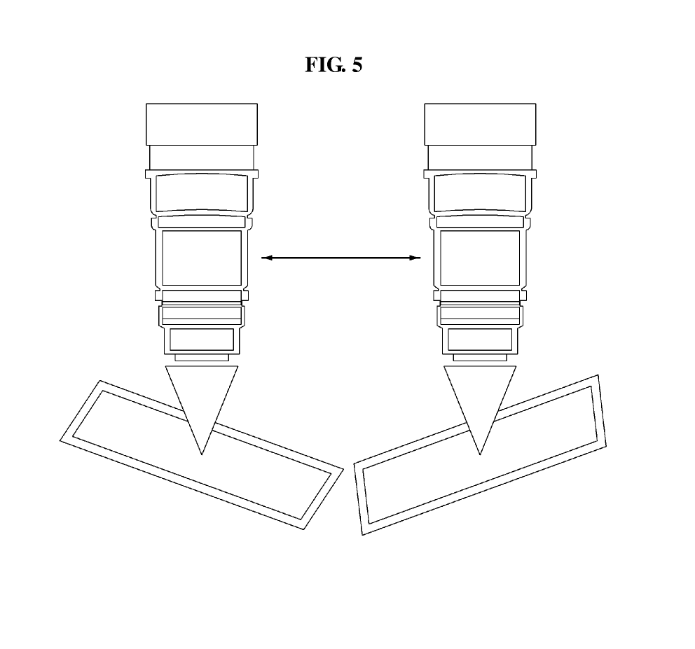

Accordingly, a method for settling the above issue is provided as illustrated in FIG. 5.

FIG. 5 is a diagram illustrating an example of a method of enhancing a resolution and a wide viewing angle of a digital holographic system according to an embodiment of the present invention.

The method of FIG. 5 may further include tilting of a film transfer stage in addition to the same condenser as used in the method of FIG. 4. In the digital holographic system, a precision film transfer stage may be employed to record a hogel unit. The corresponding film transfer stage may move vertically to adjust a size of a hogel, and move horizontally to obtain a record of an entire target image by recording a single hogel. The film transfer stage may move in a manner of scanning to record the entire target image, and transfer a film by a size of the hogel to record each hogel.

An implementation of the aforementioned recording system for enhancing the hogel resolution and the wide viewing angle may be achieved by adding a tilting function to the film transfer stage as shown in FIG. 5.

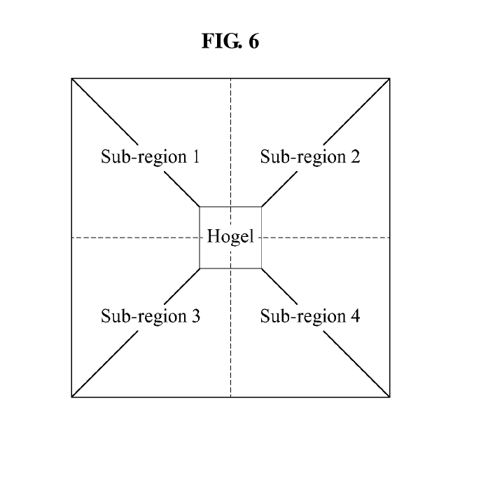

FIG. 6 is a diagram illustrating a beam and a hogel viewed from a bottom of a recording medium, for example, a film, according to an embodiment of the present invention.

Referring to FIG. 6, a region to be recorded may be divided into four sub-regions using a single condensing lens and a single SLM to obtain a record having a hogel resolution of 2K×2K.

A single hogel region of a hogel resolution set by the SLM may have a size calculated by a sum of the sub-regions 1 through 4. A high resolution result may be obtained by performing a recording four times in total for each of the four sub-regions because the recording needs to be performed for each sub-region in digital hologram recording according to an embodiment of the present invention.

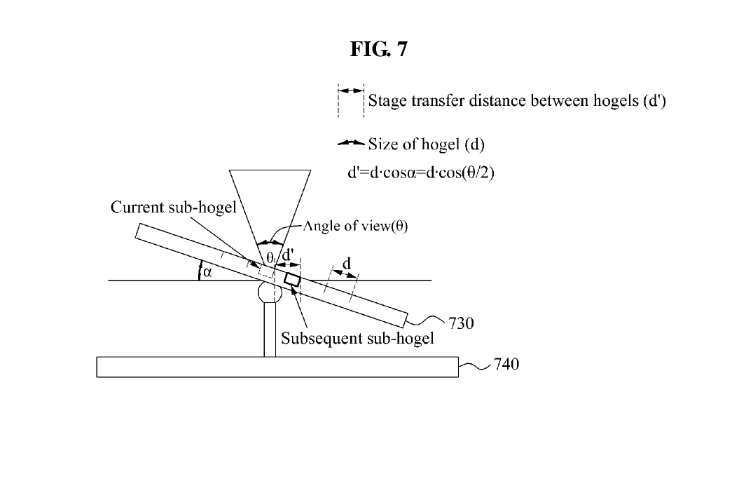

FIG. 7 is a diagram illustrating a method of calculating a tilt angle of a film transfer stage 740 according to an embodiment of the present invention.

As shown in FIG. 7, a tilted recording medium 730 may perpendicularly intersect one line of a condensed beam to be continuously connected to a beam in a different region to be recorded. Accordingly, the film transfer stage 740 may need to be tilted by a degree of a, for example, a half an angle of view 0 as shown in FIG. 7.

A transfer distance of the film transfer stage 740 may need to change during hologram recording because a surface of the recording medium 730 is tilted. In an absence of a tilt in the recording medium 730, the film transfer stage 740 may move, by a distance of a size of a sub-hogel, by adjusting a condensed beam to the size of the sub-hogel.

According to an embodiment, when a record having four divided sub-hogels and a two times greater wide viewing angle and resolution is provided, the film transfer stage 740 may move by a value obtained by multiplying a size of a hogel and a cosine value of a tilt angle of the recording medium 730 as described in the preceding.

In an equation “d′=·cos(α)=d·cos(θ/2)” represented in FIG. 7, d denotes the size of the hogel, and d′ denotes a transfer distance between hogels during recording.

A size of the condensed beam may be adjusted to the size of the sub-hogel.

According to an embodiment, achieving an identical effect is possible by adding a tilting function to an object beam condenser, or configure a single object beam condenser having a wide viewing angle and a high hogel resolution by combining multiple object beam condensers.

According to an embodiment of the present invention, there is provided a system for providing the aforementioned digital holographic recording method, the system including a memory interface having a physical interface with a recording medium to record a target image, and a processor, wherein the processor determines a multiple N of a target resolution and a wide viewing angle based on a resolution of an SLM and an angle of view of a condensing lens in the digital holographic recording system, generates a plurality of hogels from the target image based on the determined multiple N of the target resolution and the wide viewing angle, and controls the memory interface to record the target image on the recording medium using a condensed beam obtained from a parallel beam that loads the plurality hogels passing through the condensing lens.

According to an aspect of the present exemplary embodiment, there is provided an apparatus and a method for enhancing a resolution and a viewing angle of a single hogel without changing an SLM and a condensing lens by resolving issues posed by high dependency of a resolution and a viewing angle of a hogel on a resolution of the SLM and an angle of view of the condensing lens used in an object beam condenser in digital holographic printing.

The units described herein may be implemented using hardware components, software components, or a combination thereof. For example, a processing device may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

Based on a digital holographic recording method according to an aspect of the present exemplary embodiment, there is provided an apparatus and a method for enhancing a resolution and a viewing angle of a single hogel without changing an SLM and a condensing lens by resolving issues posed by high dependency of a resolution and a viewing angle of a hogel on a resolution of the SLM and an angle of view of the condensing lens used in an object beam condenser in digital holographic printing.

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined by the claims and their equivalents. For example, proper results can be achieved although the described techniques are performed in an order different from the methods described or, and/or described system, architecture, device, circuit components such as the methods described in combination with or in combination with other types or other components or substituted or replaced by equivalents. Therefore, other implementations, other embodiments, and equivalents to appended claims will be described later within the scope of the appended claims.

What is claimed is:

1. A method of enhancing a resolution and a wide viewing angle of a digital holographic system, the method comprising:
determining a multiple N of a target resolution and a wide viewing angle based on a resolution of a spatial light modulator (SLM) and an angle of view of a condensing lens;
generating a plurality of hogels from a target image based on the determined multiple N of the target resolution and the wide viewing angle; and
recording the target image on a recording medium using a condensed beam obtained from a parallel beam that loads the plurality of hogels passing through the condensing lens.

2. The method of claim 1, wherein the target image comprises:
the plurality of hogels.

3. The method of claim 1, wherein the determining of the multiple N of the target image and the wide viewing angle based on the resolution of the SLM and the angle of view of the condensing lens comprises:
determining a height of a film transfer stage based on the determined resolution.

4. The method of claim 1, wherein the generating of the plurality of hogels from the target image based on the determined multiple N of the target resolution and the wide viewing angle comprises:
generating the plurality of hogels by dividing a hogel generated in advance into sub-regions.

5. The method of claim 1, wherein the recording of the target image on the recording medium using the condensed beam obtained from the parallel beam that loads the plurality of hogels passing through the condensing lens comprises:
recording the condensed beam by diagonally condensing at a film transfer stage that transfers the recording medium.

6. The method of claim 5, wherein the recording of the condensed beam by diagonally condensing at the film transfer stage that transfers the recording medium comprises:
recording the target image by diagonally tilting the film transfer stage.

7. The method of claim 6, wherein the recording of the target image by diagonally tilting the film transfer stage comprises:
adjusting a tilt angle of the film transfer stage to perpendicularly intersect one line of the condensed beam.

8. The method of claim 6, wherein the recording of the target image by diagonally tilting the film transfer stage comprises:
transferring the film transfer stage in a unit of the plurality of hogels by adjusting the condensed beam to the unit of the plurality of hogels in an absence of a tilt of the film transfer stage.

9. The method of claim 6, wherein the recording of the target image by diagonally tilting the film transfer stage comprises:
transferring the film transfer stage in a unit of a value obtained by multiplying a size of the plurality of hogels and a cosine value of the tilt angle of the film transfer stage in a presence of a tilt of the film transfer stage.

10. The method of claim 6, wherein the recording of the target image by diagonally tilting the film transfer stage comprises:
adjusting a tilt of a condenser that transfers the condensed beam to diagonally condense the condensed beam at the film transfer stage.

11. A digital holographic system, comprising:
a memory interface comprising a recording medium on which a target image is recorded, and a physical interface; and
a processor,
wherein the processor determines a multiple N of a target resolution and a wide viewing angle based on a resolution of a spatial light modulator (SLM) and an angle of view of a condensing lens, generates a plurality of hogels from the target image based on the determined target resolution and the wide viewing angle, and control the memory interface to record the target image on the recording medium using a condensed beam obtained from a parallel beam that loads the plurality of hogels passing through the condensing lens.
